(19) United States
(12) Patent Application Publication
(10) Pub. No.: US 2025/0353541 A1
(43) Pub. Date: Nov. 20, 2025

(54) STEER-BY-WIRE STEERING SYSTEM FOR A MOTOR VEHICLE

(71) Applicant: Volkswagen Aktiengesellschaft, Wolfsburg (DE)

(72) Inventors: Mirko TRAUE, Hille (DE); Thomas KNOPP, Vechelde (DE); Heiko SCHUMANN, Braunschweig (DE); Eckbert SCHAEFER, Cremlingen (DE)

(73) Assignee: Volkswagen Aktiengesellschaft, Wolfsburg (DE)

(21) Appl. No.: 19/287,931

(22) Filed: Aug. 1, 2025

Related U.S. Application Data
(63) Continuation of application No. PCT/EP2023/085968, filed on Dec. 14, 2023.

(30) Foreign Application Priority Data
Feb. 3, 2023 (DE) 10 2023 200 888.2

(51) Int. Cl. B62D 5/04; B62D 15/02

(52) U.S. Cl. CPC B62D 5/0403; B62D 5/0421; B62D 15/0235

(57) ABSTRACT

A steer-by-wire steering system for a motor vehicle, comprising: a steering rack for transmitting a steering movement to wheels of the motor vehicle, a steering motor for driving a steering movement, a steering gear having a steering angle pinion for transmitting the steering movement of the steering motor to the steering rack, a gear wheel coupled to the steering angle pinion for determining an initial position of the steering rack when the motor vehicle is started. The gear wheel is configured relative to the steering angle pinion and arranged inside the steer-by-wire steering system in such a way that the gear wheel covers a complete steering range of the steering rack when the steering rack is moved over the steering angle pinion.

This nonprovisional application is a continuation of International Application No. PCT/EP2023/085968, which was filed on Dec. 14, 2023, and which claims priority to German Patent Application No. 10 2023 200 888.2, which was filed in Germany on Feb. 3, 2023, and which are both herein incorporated by reference.

### BACKGROUND OF THE INVENTION

### Field of the Invention

The present invention relates to a steer-by-wire steering system for a motor vehicle, a method for determining a position of a steering rack of a steer-by-wire steering system, and a motor vehicle having such a steer-by-wire steering system.

### Description of the Background Art

Steer-by-wire steering systems, which may in future be used in mass-production in the automotive field, have no mechanical connection between steering wheel and steering gear. As a result, the association between steering wheel angle and steering rack position is not fixed and can change during the course of operation. It is thus no longer possible to determine the current steering rack position with the aid of the steering wheel angle. In order to ensure operational safety in steer-by-wire steering systems, it is therefore necessary to know the steering rack position at all times.

Conventional angle sensors, whose construction is similar in design to known torque sensors, are not suitable for determining a steering rack position in a steer-by-wire steering system, since the sensors do not make absolute measurements and, furthermore, are cost-intensive. In addition, these sensors do not make “true power-on” measurements. This means that they lose their position once the steering system has been de-energized so that the sensors must be retrained in such a case.

Methods are known from the prior art that attempt to at least partially solve these problems. Thus, it is known to calculate a steering rack position or a steering angle by means of various rotary position sensors—as multiturn sensors—from a relative motion between the steering angle pinion and the steering-gear housing. A design of this nature disadvantageously requires at least two sensor transmitters and two sensor receivers, however, so that a relatively large circuit board area is also required in addition to a large number of components. Such a design is thus cost-intensive as well as failure-prone.

### SUMMARY OF THE INVENTION

It is therefore an object of the present invention to at least partially remedy the above-described disadvantages. In particular, it is an object of the present invention to make available a steer-by-wire steering system for a motor vehicle that can be produced in a simple and cost-effective manner and guarantees a reliable and precise determination of a current steering rack position so that increased operational safety of the steer-by-wire steering system is made possible.

Accordingly, the object is attained by a steer-by-wire steering system, by a method, and by a motor vehicle. Of course, features and details that are described in connection with the steer-by-wire steering system according to the invention also apply in connection with the method according to the invention or the motor vehicle according to the invention and vice versa in each case, so mutual reference is or can always be made with regard to the disclosure of the individual aspects of the invention.

According to the invention, a steer-by-wire steering system for a motor vehicle is provided. In this connection, the steer-by-wire steering system according to the invention comprises a steering rack for transmitting a steering movement to wheels of the motor vehicle, a steering motor for controlling a steering movement, a steering gear with a steering angle pinion for transmitting the steering movement of the steering motor to the steering rack, and a gear wheel coupled to the steering angle pinion for determining an initial position of the steering rack at a starting process of the motor vehicle, wherein the gear wheel is configured relative to the steering angle pinion and arranged inside the steer-by-wire steering system in such a manner that the gear wheel covers a complete steering range of the steering rack (with less than one rotation about its rotational axis) when the steering rack is moved by means of the steering angle pinion.

According to the invention, therefore, the concrete steer-by-wire steering system is designed to permit a reliable and precise determination of a current steering rack position in a simple and economical manner, and in this way to ensure increased operational safety, in particular by means of the arrangement of a gear wheel that is configured relative to a steering angle pinion, and arranged inside the steer-by-wire steering system, in such a manner that the gear wheel covers a complete steering range of the steering rack (with a rotation angle of <360°) when the steering rack is moved by means of the steering angle pinion. Owing to the arrangement according to the invention, it is possible, in particular, to dispense with the use of various rotary position sensors as multiturn sensors or multistage methods for determining a position of a steering rack.

The method according to the invention can advantageously be carried out in motor vehicles such as automobiles and trucks. It is a matter of course, however, that the method can likewise be used with commercial vehicles, ships, trains, and even flying objects. The concrete steering rack of the motor vehicle can, in particular, be provided for the purpose of transmitting a steering movement to the wheels of the motor vehicle. An “initial position of a steering rack” of a motor vehicle can preferably be understood as the first position of a steering rack determined before a starting process and/or a steering process is carried out. In contrast, a “current position of a steering rack” of a motor vehicle can preferably be understood, on the other hand, as the present position of a steering rack determined after a starting process and/or a steering process is carried out. A “steering motor” preferably can be understood concretely as an actuator or an electric machine for driving a steering movement. A “coverage of the complete steering range” provided according to the invention can be understood here to mean, in particular, that the gear wheel coupled to the steering angle pinion rotates less than one time about its axis (rotation angle <360°) as a result of a movement of the steering angle pinion for driving the steering rack when the steering rack, driven by the steering angle pinion, is moved from one steering stop to the opposite steering stop. In particular, as a result of its diameter, the gear wheel can have a reduction such that it rotates less than one time about its axis during a complete steering range of the steering rack from one steering stop to the opposite steering stop. Preferably, the rotation angle can even be ≤340° in order to be able to provide, e.g., a reserve in each direction for cases of misuse (oversteering of the end stop). The concrete steer-by-wire steering system preferably can be designed in the form of a “single-pinion steering system.” The gear wheel and the steering angle pinion preferably can form a transmission in accordance with their coupling in this case. An angle sensor transmitter positioned on the gear wheel can thus transmit an unambiguous angle signal along the entire steering range of the steering rack without the need for multiple signals from multiple rotary position sensors to be offset against one another.

With regard to simple detection of a rotation angle as well as to ensure an especially safe implementation of the concrete steer-by-wire steering system, provision can advantageously be made according to the invention that an angle sensor for sensing a rotation angle of the gear wheel is provided, wherein the angle sensor preferably is designed such that data acquisition can be performed in ASIL D quality. In order to ensure a correspondingly high fault tolerance in compliance with ASIL D quality, a redundant or dual redundant power supply and/or a redundant or dual redundant communication connection can be provided, for example. The angle sensor can be designed in the form of a circuit board or the like, for example.

Within the scope of a structurally easy-to-produce and unsusceptible implementation of a concrete steer-by-wire steering system, provision can be made in this connection, for example, that the angle sensor is designed in the form of a magnetic sensor, wherein a magnet is arranged on the gear wheel for the purpose of sensing a rotation angle, wherein the magnet preferably is arranged between the angle sensor and the gear wheel. The magnet in this case preferably can be arranged on a shaft on which the gear wheel is mounted, preferably on a bearing of the shaft. The magnet in this case can likewise cover the entire range of the steering rack, or execute one revolution over the entire range of the steering rack. Located on the driven gear wheel as sensor transmitter is a two-pole magnet, for example. Any form of inductive or optical transmitter is also possible, however.

Within the scope of a stable and compact arrangement as well as ensuring an especially exact determination of a steering rack position, provision furthermore can concretely be made that a cover is provided to accommodate the gear wheel and/or the angle sensor, wherein the gear wheel preferably is arranged between a top of the cover and the angle sensor. Alternatively, provision can also be made that the angle sensor is arranged between a top of the cover and the gear wheel. The cover preferably can be designed in the form of a plastic cover. In addition, the cover can have an integrated connector or an integrated cable end. The electronics with the sensor receiver advantageously can be integrated in the sensor cover in such a manner that they are optimally protected from external influences such as dirt and moisture during installation and in operation.

To ensure the coverage provided according to the invention of the entire steering range of the steering rack by means of the gear wheel, provision advantageously can concretely be made that the transmission ratio between the steering angle pinion and the gear wheel is designed such that a complete steering range of the steering rack is executable by means of a rotation of the gear wheel about its rotational axis with a rotation angle of <360°, preferably with a rotation angle of <340°. A transmission ratio with a gear ratio of >2, preferably of >3, in particular of 3.25, can be present between the steering angle pinion and the gear wheel in this case. Within the scope of an economical as well as low-noise and low-abrasion implementation, provision can furthermore be made that the gear wheel is made of a plastic, for example. The gear wheel can be connected to a bearing by, e.g., heat staking or thermoplastic staking, and be arranged on a shaft.

Within the scope of a simple and energy-saving determination of a current position of a steering rack after a determination of an initial position of a steering rack at a startup of a motor vehicle, provision furthermore can advantageously be made that a motor position sensor is provided for determining a current position of a steering rack after a starting process of the motor vehicle on the basis of the initial position of the steering rack, wherein the motor position sensor is designed in the form of a magnetic sensor. The angle sensor for sensing the angular position of the gear wheel then preferably is not in operation here, which not only saves energy but also improves the electromagnetic compatibility of the electrical components involved, in particular the electromagnetic sensors involved.

To ensure a durable, preferably abrasion-free, arrangement of a transmission composed of a gear wheel and a steering angle pinion, according to the invention provision can be made, in particular, that the gear wheel and/or the angle sensor are movable toward the steering angle pinion, preferably are movable by at least 3 mm toward the steering angle pinion. In this way, a material-friendly, zero-play arrangement between the gear wheel and the steering angle pinion is achievable, in particular.

In order to achieve a zero-play arrangement between the gear wheel and the steering angle pinion, provision likewise can alternatively be made that the gear wheel is eccentrically mounted on a shaft. The gear wheel with the rotation angle sensor in this case can be mounted in the steering gear housing, for example, and be displaced radially with respect to the steering angle pinion with the aid of the eccentric shaft so that the play of the teeth can be adjusted.

To ensure a zero-play arrangement between the gear wheel and the steering angle pinion, it is alternatively possible, furthermore, that a spring element for preadjusting a radial play between the gear wheel and the steering angle pinion is provided, wherein the spring element preferably is permanently arranged on a housing of the steering gear. The spring element in this case can be attached to, e.g., the shaft of the gear wheel and/or a bearing of the steering angle pinion, and in this way minimize a play between the gear wheel and the steering angle pinion.

Furthermore, a method for determining a position of a steering rack of a steer-by-wire steering system of a motor vehicle, preferably of an above-described steer-by-wire steering system, is also the subject matter of the invention. In this case, the method according to the invention comprises the steps of: a driving of a steering angle pinion for moving a steering rack between a first steering stop and an opposite, second steering stop and, simultaneously, a gear wheel for determining an initial position of the steering rack; a moving of the steering rack between the first steering stop and the second, opposite, steering stop by means of the steering angle pinion; a moving of the gear wheel about a rotational axis with a rotation angle of <360°; as well as a determining of an initial position of the steering rack through the rotation angle of the gear wheel about the rotational axis. As a result, the method according to the invention offers the same advantages as have already been described in detail in relation to the steer-by-wire steering system according to the invention.

It is a matter of course in the present case, moreover, that individual, multiple, or all mandatory and/or optional steps of the method according to the invention can be carried out in the proposed order, but also can be carried out differently from the proposed order. In this connection, individual, multiple, or all mandatory and/or optional steps of the method according to the invention can, in particular, be carried out repeatedly, for example be repeated cyclically. It is furthermore a matter of course that individual, multiple, or all of the mandatory and optional steps of the method according to the invention can, concretely, also be carried out at least partially automatically or in automated fashion and/or in self-learning fashion, in particular can be implemented by a computer, preferably can be carried out by computer-implemented simulation methods.

Furthermore, a motor vehicle that includes an above-described steer-by-wire steering system is also the subject matter of the invention. As a result, the motor vehicle according to the invention offers the same advantages as have already been described in detail in relation to the steer-by-wire steering system according to the invention or the method according to the invention.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a steer-by-wire steering system according to the invention for a motor vehicle according to an example in a sectional view,

FIG. 2 shows a part of the steer-by-wire steering system according to the invention for a motor vehicle according to the example in a sectional view,

FIG. 3 shows a first (top) and second (bottom) partial sectional view of the steer-by-wire steering system according to the invention according to the example,

FIG. 4 shows a first (top) and second (bottom) partial sectional view of the steer-by-wire steering system according to the invention according to an example,

FIG. 5 shows a first (top) and second (bottom) partial sectional view of the steer-by-wire steering system according to the invention according to an example,

FIG. 6 shows the individual steps of a method according to the invention for determining the position of a steering rack of a steer-by-wire steering system of a motor vehicle.

### DETAILED DESCRIPTION

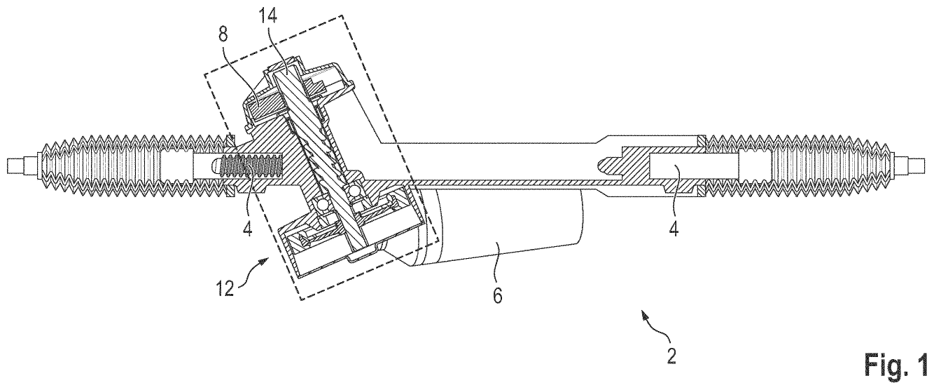

FIG. 1 shows a steer-by-wire steering system 2 according to the invention for a motor vehicle according to a first example in a sectional view.

As can be seen according to FIG. 1, the steer-by-wire steering system 2 according to the invention comprises a steering rack 4 for transmitting a steering movement to wheels of the motor vehicle, a steering motor 6 for controlling a steering movement, a steering gear 12 with a steering angle pinion 14 for transmitting the steering movement of the steering motor 6 to the steering rack 4, a gear wheel 8 coupled to the steering angle pinion 14 for determining an initial position of the steering rack 4 at a starting process of the motor vehicle, wherein the gear wheel 8 is configured relative to the steering angle pinion 14 and arranged inside the steer-by-wire steering system 2 in such a manner that the gear wheel 8 covers a complete steering range of the steering rack 4 when the steering rack 4 is moved by means of the steering angle pinion 14.

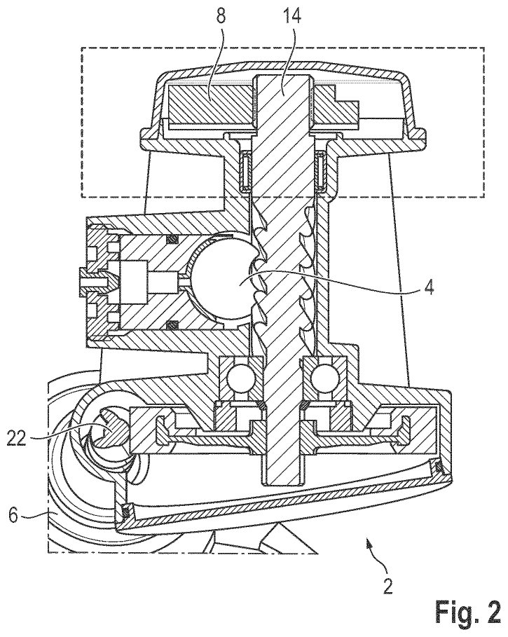

FIG. 2 shows the part of the steer-by-wire steering system 2 according to the invention located in the dashed box in FIG. 1 in a somewhat enlarged representation.

As can be seen according to FIG. 2, the steering angle pinion 14 is driven by means of the worm drive 22 that is driven by the steering motor 6.

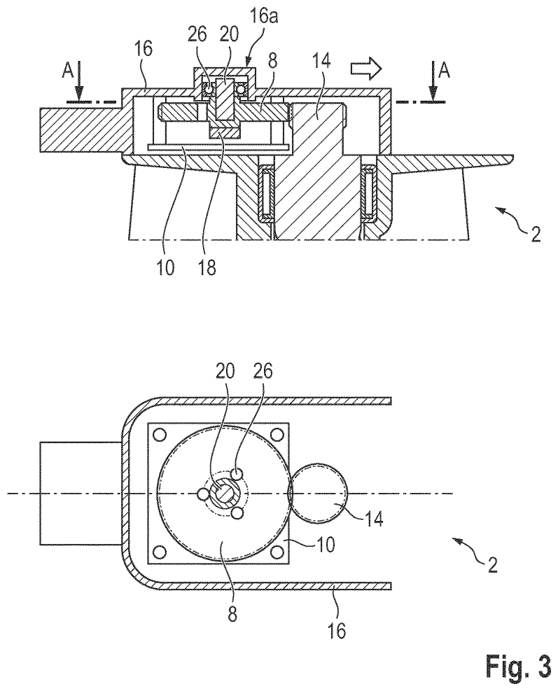

FIG. 3 shows a first (top) and second (bottom) partial sectional view of the part of the steer-by-wire steering system 2 according to the invention located in the dashed box in FIG. 2 according to the first example, wherein the bottom representation shows a partial sectional view of the top representation along the section line A-A.

As can be seen according to FIG. 3, the steer-by-wire steering system 2 additionally comprises an angle sensor 10 for sensing a rotation angle α of the gear wheel 8 coupled to the steering angle pinion 14, wherein the angle sensor 10 in the present case is designed for data acquisition in ASIL D quality. The gear wheel 8 is rotatably mounted on the shaft 20 by means of the bearing 26 in this case.

The angle sensor 10 is designed in the form of a magnetic sensor in this case, wherein a magnet 18 is arranged on the gear wheel 8 for sensing a rotation angle α between the angle sensor 10 and the gear wheel 8.

Furthermore, a cover 16 is provided to accommodate the gear wheel 8 and the angle sensor 10, wherein the gear wheel 8 in the present case is arranged between a top 16a of the cover 16 and the angle sensor 10.

The transmission ratio between the steering angle pinion 14 and the gear wheel 8 is designed in the present case such that a complete steering range of the steering rack 4 is executable by means of a rotation of the gear wheel 8 about its rotational axis X with a rotation angle α of <360°, preferably with a rotation angle α of <340°.

The gear wheel 8 and/or the angle sensor 10 are movable toward the steering angle pinion 14 in this case, preferably by at least 3 mm, in order to adjust a zero-play coupling between the gear wheel 8 and the steering angle pinion 14.

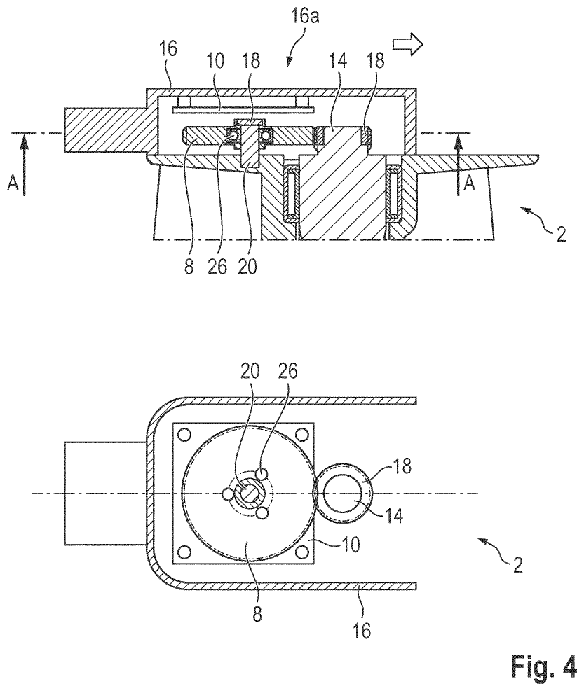

FIG. 4 shows a first (top) and second (bottom) partial sectional view of the part of the steer-by-wire steering system 2 according to the invention located in the dashed box in FIG. 2 according to a second example, wherein the bottom representation shows a partial sectional view of the top representation along the section line A-A.

As can be seen according to FIG. 4, according to the second example the angle sensor 10 is arranged between the top 16a of the cover 16 and the gear wheel 8, wherein the gear wheel 8 in the present case is mounted eccentrically on the shaft 20 and in this way ensures or creates a zero-play coupling with the steering angle pinion 14. In addition, the steering angle pinion 14 is also provided with a magnet 18.

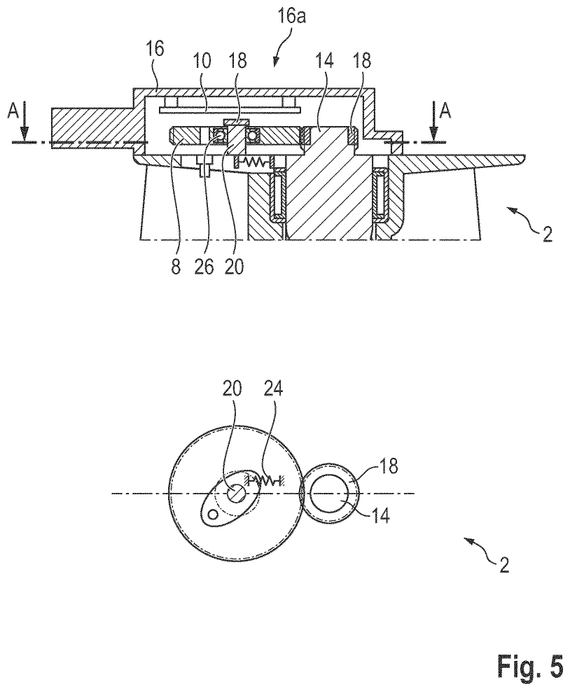

FIG. 5 shows a first (top) and second (bottom) partial sectional view of the part of the steer-by-wire steering system 2 according to the invention located in the dashed box in FIG. 2 according to a third example, wherein the bottom representation shows a partial sectional view of the top representation along the section line A-A.

As can be seen according to FIG. 5, the third example additionally has a spring element 24 for preadjusting a radial play between the gear wheel 8 and the steering angle pinion 14, which in the present case is permanently arranged on the housing of the steering gear 12.

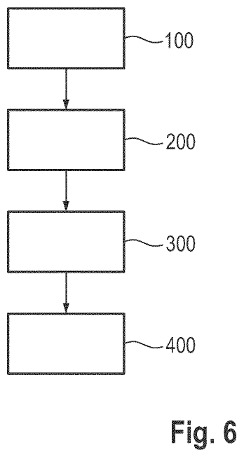

Finally, FIG. 6 shows the individual steps of a method according to the invention for determining the position of a steering rack 4 of a steer-by-wire steering system 2 of a motor vehicle.

As can be seen according to FIG. 6, the method according to the invention comprises the steps of: a driving 100 of a steering angle pinion 14 for moving a steering rack 4 between a first steering stop and an opposite, second steering stop and, simultaneously, a gear wheel 8 for determining an initial position of the steering rack 4; a moving 200 of the steering rack 4 between the first steering stop and the second, opposite, steering stop by means of the steering angle pinion 14; a moving 300 of the gear wheel 8 about a rotational axis X with a rotation angle α of <360°; as well as a determining 400 of an initial position of the steering rack 4 through the rotation angle α of the gear wheel 8 about the rotational axis X.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A steer-by-wire steering system for a motor vehicle, the system comprising:
a steering rack to transmit a steering movement to wheels of the motor vehicle;
a steering motor to control a steering movement,
a steering gear with a steering angle pinion to transmit the steering movement of the steering motor to the steering rack; and
a gear wheel coupled to the steering angle pinion to determine an initial position of the steering rack at a starting process of the motor vehicle,
wherein the gear wheel is configured relative to the steering angle pinion and arranged inside the steer-by-wire steering system such that the gear wheel covers a complete steering range of the steering rack when the steering rack is moved via the steering angle pinion.

2. The steer-by-wire steering system according to claim 1, further comprising an angle sensor for sensing a rotation angle of the gear wheel, wherein the angle sensor is designed such that data acquisition is adapted to be performed in ASIL D quality.

3. The steer-by-wire steering system according to claim 2, wherein the angle sensor is a magnetic sensor, wherein a magnet is arranged on the gear wheel for the purpose of sensing a rotation angle, wherein the magnet is arranged between the angle sensor and the gear wheel.

4. The steer-by-wire steering system according to claim 1, wherein a cover is provided to accommodate the gear wheel and/or the angle sensor, wherein the gear wheel is arranged between a top of the cover and the angle sensor.

5. The steer-by-wire steering system according to claim 1, wherein a transmission ratio is present between the steering angle pinion and the gear wheel that is designed such that a complete steering range of the steering rack is executable by a rotation of the gear wheel about its rotational axis with a rotation angle of <360°, or with a rotation angle of <340°.

6. The steer-by-wire steering system according to claim 1, wherein a motor position sensor is provided for determining a current position of a steering rack after a starting process of the motor vehicle on the basis of the initial position of the steering rack, and wherein the motor position sensor is a magnetic sensor.

7. The steer-by-wire steering system according to claim 1, wherein the gear wheel and/or the angle sensor are movable toward the steering angle pinion or are movable by at least 3 mm toward the steering angle pinion.

8. The steer-by-wire steering system according to claim 1, wherein the gear wheel is eccentrically mounted on a shaft.

9. The steer-by-wire steering system according to claim 1, wherein a spring element for preadjusting a radial play between the gear wheel and the steering angle pinion is provided, and wherein the spring element is permanently arranged on a housing of the steering gear.

10. A method for determining a position of a steering rack of a steer-by-wire steering system of a motor vehicle, preferably of a steer-by-wire steering system according to claim 1, the method comprising:
driving a steering angle pinion for moving a steering rack between a first steering stop and an opposite, second steering stop and, substantially simultaneously, a gear wheel for determining an initial position of the steering rack;
moving the steering rack between the first steering stop and the second, opposite, steering stop via the steering angle pinion;
moving the gear wheel about a rotational axis with a rotation angle of <360°; and
determining an initial position of the steering rack through the rotation angle of the gear wheel about the rotational axis.

11. A motor vehicle comprising the steer-by-wire steering system according to claim 1.
